(19) United States
(12) Patent Application Publication
(10) Pub. No.: US 2025/0191807 A1
(43) Pub. Date: Jun. 12, 2025

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU GONG, Huaian (CN); Xiao-Fei Liu, Huaian (CN); A-Nan Yang, Huaian (CN); Han-Run Xie, Huaian (CN); Lu-Yu Chang, New Taipei (TW)

(21) Appl. No.: 18/973,644

(22) Filed: Dec. 9, 2024

(30) Foreign Application Priority Data
Dec. 11, 2023 (CN) 202323369854.0

(51) Int. Cl. H01B 7/18; H01B 1/02; H01B 3/44; H01B 7/02; H01B 11/00

(52) U.S. Cl. CPC H01B 7/185; H01B 1/026; H01B 3/445; H01B 7/0216; H01B 7/0275; H01B 11/002

(57) ABSTRACT

A cable includes: two inner conductors arranged in parallel; and a sheath layer covering outside the two inner conductors, plural air holes being provided on the sheath layer; wherein the plural air holes are arranged at intervals and surround the two inner conductors as a whole, and there are no air holes between the two inner conductors.

### BACKGROUND OF THE INVENTION

### Field of the Invention

The present invention relates to a cable, and more particularly to a cable used to transmit high-frequency signals.

### Description of Related Arts

U.S. Pat. No. 8,455,761 discloses a cable including two inner conductors, an insulating layer covering outside each inner conductor, an outer conductor layer covering outside the insulating layer, and a protective layer covering outside the outer conductor layer. Each insulating layer is provided with six voids each with an elliptical cross-section surrounding each inner conductor. China Patent No. 215341995 discloses a cable including two inner conductors, an insulating layer covering outside the two inner conductors, and a shielding layer covering outside the insulating layer. A plurality of through holes are provided at intervals in the insulating layer and respectively surrounding each inner conductor.

### SUMMARY OF THE INVENTION

A main object of the present invention is to provide an improved cable that can reduce the attenuation loss of the cable at high frequencies and improve the overall electrical performance of the cable.

To achieve the above-mentioned object, a cable comprises: two inner conductors arranged in parallel; and a sheath layer covering outside the two inner conductors, a plurality of air holes being provided on the sheath layer; wherein the plurality of air holes are arranged at intervals and surround the two inner conductors as a whole, and there are no air holes between the two inner conductors.

Compared to prior art, through the arrangement of multiple air holes on the sheath layer, the relative dielectric coefficient of the sheath layer is reduced, thereby reducing the attenuation loss of the cable at high frequencies.

### BRIEF DESCRIPTION OF DRAWINGS

FIG. 1 is a cross-sectional view of a first embodiment of the present invention; and

FIG. 2 is a cross-sectional view of a second embodiment of the present invention.

### DETAILED DESCRIPTION OF THE DRAWINGS

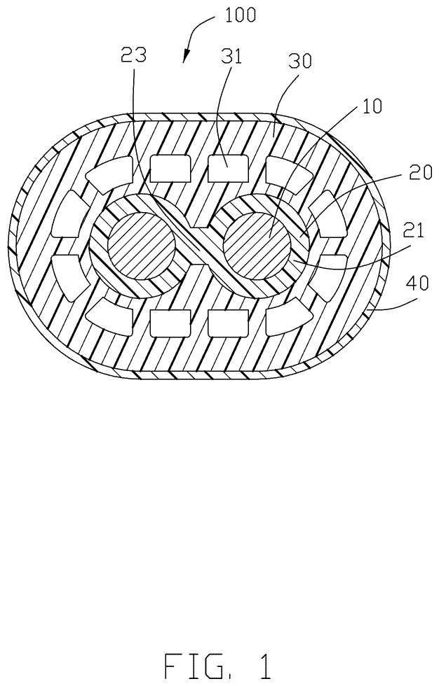

Referring to FIG. 1 which shows a cable 100 of the present invention. The cable 100 includes two inner conductors 10 arranged in parallel and a sheath layer 30 arranged outside the two inner conductors 10. The sheath layer 30 is provided with a plurality of air holes 31, and the plurality of air holes 31 are arranged at intervals and surround the two inner conductors 10 as a whole. There are no air holes between the two inner conductors 10. Each air hole is roughly quadrilateral in shape. The plurality of air holes 31 are evenly arranged in a regular shape as a whole, and their overall shape is close to a racetrack shape. The plurality of air holes 31 are approximately disposed at the middle position of the sheath layer 30. The material of the sheath layer 30 is FEP (fluorinated ethylene propylene), and the inner conductor 10 is made of the silver-plated copper.

In a first embodiment, an inner insulating layer 20 is provided between the inner conductor 10 and the sheath layer 30. The inner insulating layer 20 is extruded outside the two inner conductors. The inner insulating layer 20 is generally eyeglass-shaped, and includes two annular portions 21 respectively surrounding each inner conductor 10 and a connecting portion 23 connecting the two annular portions 21. The sheath layer 30 is extruded outside the inner insulating layer 20. In a cross section perpendicular to the extension direction of the cable, the sum of the areas of the plurality of air holes 31 on the sheath layer 30 is greater than the area of the inner insulating layer 20. The thickness of the sheath layer 30 is greater than the thickness of the inner insulating layer 20. The materials of the sheath layer 30 and the inner insulating layer 20 are different. The inner insulating layer 20 may be made of PP, PE, or other materials. A shielding layer 40 is provided outside the sheath layer 30. The shielding layer 40 is spirally wound or longitudinally wrapped around the outside of the sheath layer 30.

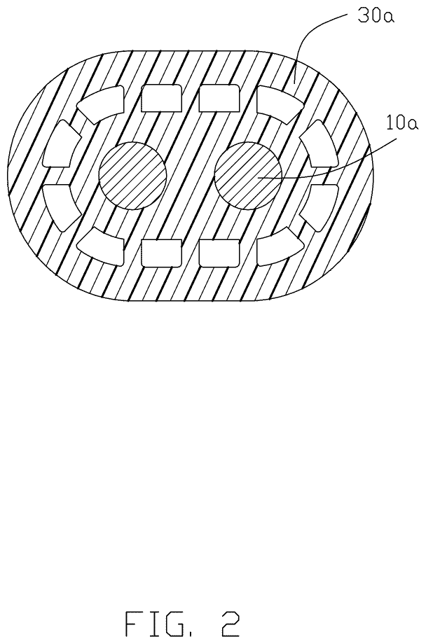

Referring to FIG. 2 which shows a second embodiment, compared with the first embodiment, the sheath layer 30a is directly extruded outside the two inner conductors 10a. That is, no insulation layer is provided between the inner conductor and the sheath layer. There is no shielding layer outside the sheath layer. Everything else remains unchanged.

The arrangement of evenly arranged air holes 31 in the sheath layer 30 of the cable can reduce the relative dielectric coefficient of the sheath layer and reduce the capacitance effect. As a result, the electromagnetic wave transmission rate is accelerated, the attenuation loss of the cable at high frequencies is reduced, and the overall electrical performance of the cable is improved.

1. A cable comprising:
two inner conductors arranged in parallel; and
a sheath layer covering outside the two inner conductors, a plurality of air holes being provided on the sheath layer;
wherein the plurality of air holes are arranged at intervals and surround the two inner conductors as a whole, and there are no air holes between the two inner conductors.

2. The cable as claimed in claim 1, wherein the plurality of air holes are uniformly arranged in a regular shape as a whole.

3. The cable as claimed in claim 2, wherein an inner insulating layer is provided between the inner conductor and the sheath layer, and the inner insulating layer is extruded outside the two inner conductors.

4. The cable as claimed in claim 3, wherein the inner insulating layer comprises two annular portions respectively surrounding each inner conductor and a connecting portion connecting the two annular portions.

5. The cable as claimed in claim 3, wherein in a cross section perpendicular to the extension direction of the cable, the sum of the areas of the plurality of air holes on the sheath layer is greater than the area of the inner insulating layer.

6. The cable as claimed in claim 3, wherein the sheath layer is extruded outside the inner insulating layer.

7. The cable as claimed in claim 3, wherein the thickness of the sheath layer is greater than that of the inner insulating layer.

8. The cable as claimed in claim 3, further comprising a shielding layer disposed outside the sheath layer.

9. The cable as claimed in claim 1, wherein the material of the sheath layer is fluorinated ethylene propylene.

10. The cable as claimed in claim 1, wherein the material of the inner conductor is silver-plated copper.
